(19) United States
(12) Patent Application Publication
(10) Pub. No.: US 2011/0062743 A1
(43) Pub. Date: Mar. 17, 2011

(54) ROLL-OUT COVER SYSTEM FOR OPEN CONTAINER VEHICLES

(75) Inventors: Celio Gomes, York, ME (US); David F. Rivers, Wallingford, CT (US)

(73) Assignee: Patriot Lift Co., LLC

(21) Appl. No.: 12/949,440

(22) Filed: Nov. 18, 2010

Related U.S. Application Data
(63) Continuation of application No. 10/556,154, filed on Jan. 31, 2008, now abandoned.
(60) Provisional application No. 60/466,004, filed on Apr. 28, 2003.
(60) Provisional application No. 60/466,001, filed on Apr. 28, 2003.

(51) Int. Cl. B60J 11/02

(52) U.S. Cl. 296/98

(57) ABSTRACT

A roll-out cover system for a container having an open top is provided that includes a cover, a pair of pivot arms, a gearbox, a motor, a drive mechanism, and a controller. The cover has a leading end and a trailing end. The pivot arms are positioned on respective sidewalls of the container. Each pivot arm has a free end connected to a leading end of the cover, and a pivot end. The pivot arms are pivotable between a first position wherein the cover is retracted from the open top, and a second position wherein the cover is extended substantially over the open top. The gearbox has an input shaft and an output shaft connected to the pivot arms. The controller selectively controls the motor and coupled gearbox to operate the drive mechanism and connected pivot arms between the first position wherein the cover is retracted, and the second position wherein the cover is extended substantially over the open top.

### CROSS REFERENCE TO RELATED APPLICATIONS

This application is a continuation of U.S. patent application Ser. No. 10/556,154 filed Jan. 31, 2008, which is a national stage application of PCT Patent Application No. PCT/US2004/012903 filed Apr. 24, 2004, which claims priority to U.S. Provisional Patent Application Nos. 60/466,001 filed on Apr. 28, 2003 and 60/466,004 filed on Apr. 28, 2003 entitled. The disclosure of each of the above-identified applications is incorporated herein by reference.

### BACKGROUND OF THE INVENTION

1. Field of the Invention

The present invention relates to open top container vehicles in general, and in particular to apparatus for operating a roll-out cover for an open top container vehicle, such as a dump truck.

2. Background Information

It is known for trucks (e.g., dump trucks, container trucks, etc.) to use open top containers for transporting earth, sand, stone, waste, debris or similar materials. Open top containers are filled through the open top, and emptied by pivotally raising the container at an angle. A rear wall of the container typically swings open (or can be detached) as or before the container is raised, and the material exits through the opening. However, material is loaded into the container can be easily agitated—e.g., from bumpy roads or external winds—and is susceptible to being displaced from the container through the open top. Accordingly, the open top of the container is often covered during transport so as to prevent waste and debris from being ejected from the container.

As known in the art, a flexible cover extending transversely across the container width, and having sufficient length to cover at least the entire length of the container is provided on the container. Because loading of material is usually accomplished through the open top of the container, the flexible cover usually has a storage location where the cover is positioned out of the way during loading, and often unloading, of material from the container. The flexible cover is typically rolled out from the front of the container to the rear of the container, extending over the open top of the container.

Some prior art cover systems include a pair of pivot arms, a cross bar, and a take-up roller. One of the pivot arms is positioned on each side of the container. The cross bar extends between and is connected to the pivot arms. The pivot arms and attached crossbar are pivotable from a first position adjacent the front of the container to a second position adjacent the rear of the container. In some embodiments, the take-up roller is fixed to the front of the container (e.g., a dump body) or to the truck adjacent the front of the container. One end of the cover is attached to the take-up roller and the other end is attached to the crossbar. Pivoting the mins and crossbar from the front of the container to the rear of the container causes the cover to be unrolled from the take-up roller and the container covered. When the aims and crossbar are pivoted back toward the front of the container, the cover is rolled back onto the take-up roller. In other embodiments, the take-up roller is attached to the crossbar. One end of the cover is attached to the take-up roller and the other end is attached to the front of the container or to the truck adjacent the front of the container. Pivoting the arms and crossbar from the front of the container to the rear of the container causes the cover to be unrolled from the take-up roller and the container covered. When the arms and crossbar are pivoted back toward the front of the container, the cover is rolled back onto the take-up roller.

The pivot arms are commonly driven between covered and uncovered positions with an operating shaft assembly mounted on the frame of the truck or the container. For example, the operating shaft assembly may include a shaft running between the pivoting arms at the base of the container. The shaft communicates with each arm at its respective pivot point, and acts to pivot the arms upon rotation of the shaft.

While some roll-out cover systems make use of complex automated actuators and drive shafts specifically designed into the truck designs, several roll out cover systems rely on the operator to manually effect operation of the cover system between the covered and uncovered positions. That is, the operating shaft assembly is provided with an operating drive shaft that can be hand cranked to move the cover between the covered position and the uncovered position. The operating drive shaft is typically connected to a gearbox and chain drive. The gearbox provides some mechanical advantage to effort required to crank the mechanism. Covering and uncovering an open-top container still takes a substantial amount of time, however. If the operating drive shaft is located above the cab, the operator must also position himself on the cab, usually in an awkward position, to operate the hand crank. What is needed is an apparatus for covering and uncovering an open top container in a time efficient manner, with reduced operator effort and intervention, and with overall easier operation. Additionally, there is a need to retrofit existing truck containers adapted with roll-out covers using manual operation systems and components with automatic operation systems, where such retrofit is conducted with minimal reconstruction or replacement of the components of the existing operation systems.

### DISCLOSURE OF THE INVENTION

According to the present invention, a roll-out cover system for a container having an open top is provided that includes a cover, a pair of pivot arms, a gearbox, a motor, a drive mechanism, and a controller. The cover has a leading end and a trailing end. The pivot arms are positioned on respective sidewalls of the container. Each pivot arm has a free end connected to the leading end of the cover, and a pivot end. The pivot arms are pivotable between a first position wherein the cover is retracted from the open top, and a second position wherein the cover is extended substantially over the open top. The gearbox has an input shaft and an output shaft. The motor is coupled to the input shaft of the gearbox. The drive mechanism is coupled to the output shaft of the gearbox and connected to the pivot arms. The controller selectively controls the motor and coupled gearbox to operate the drive mechanism and connected pivot arms between the first position wherein the cover is retracted, and the second position wherein the cover is extended substantially over the open top.

In a preferred embodiment, the motor is a pneumatic motor connected to a source of compressed air. A pneumatic motor avoids the problems associated with hydraulic motors and electrical motors in an outdoor environment. Additionally, the pneumatic motor of the present invention can be connected to the pre-existing air supply of a truck's brake system.

The present roll-out cover system provides several advantages over existing cover systems. For example, the present roll-out cover system can be operated in a power-assist mode or a manual mode. In the power assist mode, a motor is used to drive the pivot arms and cover between an uncovered (or “retracted”) position and a covered (or “substantially extended”) position, or vice versa. In the event the power required to operate the system is not available, the present system can be operated manually. In the power assist mode, the present roll-out cover system can be operated remotely; e.g., from the cab of the truck.

Another advantage of the present system is the labor saved by the operator. In the power-assist mode, the work of actuating the roll-out cover is done by the present system, not the operator. The elimination of the physical work also decreases the chance of operator injury.

Another advantage of the present invention is its ability to be retrofitted onto existing cover systems. An embodiment of the present invention can be combined with certain manual cover systems to enable them to be operated in a power-assist mode. Because this embodiment advantageously utilizes certain existing components, the modifications and cost to retrofit is minimized. In addition, the retrofit is compatible with the existing manual actuation system. Hence, an existing cover system retrofitted with the present invention can be operated in a power-assist mode or a manual mode.

Another advantage of the present invention is that it can be used with a variety of power sources. If a pneumatic motor is employed, compressed air from a source independent of the truck can be used. In the preferred embodiment, however, the pneumatic motor is connected to a source of compressed air portable with the truck; e.g., a brake system air. As a result, the medium that powers the pneumatic motor travels with the truck.

These and other objects, features and advantages of the present invention will become apparent in light of the drawings and detailed description of various embodiments of the present invention provided below.

### BRIEF DESCRIPTION OF THE DRAWINGS

FIG. 1 is a perspective view showing an open top dump truck with a roll-out cover in the uncovered position.

FIG. 2 is a perspective view showing an open top dump truck with a roll-out cover in the covered position.

FIG. 3 is a diagram showing the relationship between the gearbox, the drive mechanism, the motor, and the pivoting arms for the present system example shown in FIGS. 1 and 2.

FIG. 4 is a perspective view of an embodiment of the present invention system shown in the context of an open top dump truck example, where the motor, gearbox and drive mechanism of the present invention are positioned on the cab of the truck near the front end of the cover.

FIG. 5 is a diagram showing the relationship between the gearbox, the drive mechanism, the motor, and the front roller, for the present system example shown in FIG. 4.

FIG. 6 is a diagram showing the relationship between the controller and the motor for the present invention.

FIG. 7 is a diagrammatic view of a coupling used in some embodiments of the present invention.

### DETAILED DESCRIPTION OF EMBODIMENTS OF THE PRESENT INVENTION

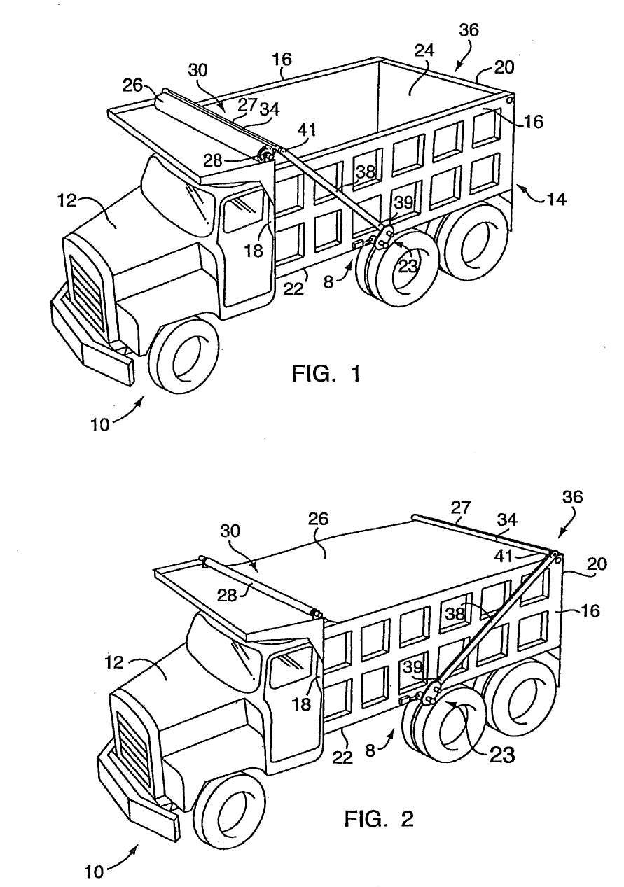

Referring to FIGS. 1-7, the present invention roll-out cover system 8 is described below in terms of a dump truck application. The dump truck 10 is an example of an open container type truck. The present roll-out cover system can be used with a variety of open container type trucks and is not, therefore, limited to use with dump trucks.

The dump truck 10 comprises a front cab 12 and a rear tiltable, open top container 14 having a pair of side walls 16, a front wall 18, a rear wall 20, and a bottom wall 22 defining an interior chamber 24 in which top soil, sand, stone, waste, debris, or similar material may be held for transportation. The rear wall 20 is typically adapted to swing open when the container 14 is tilted upwardly to dump the material therefrom. The container is described as having a front end 30 disposed adjacent the cab 12 of the truck and a rear end 36 disposed oppositely.

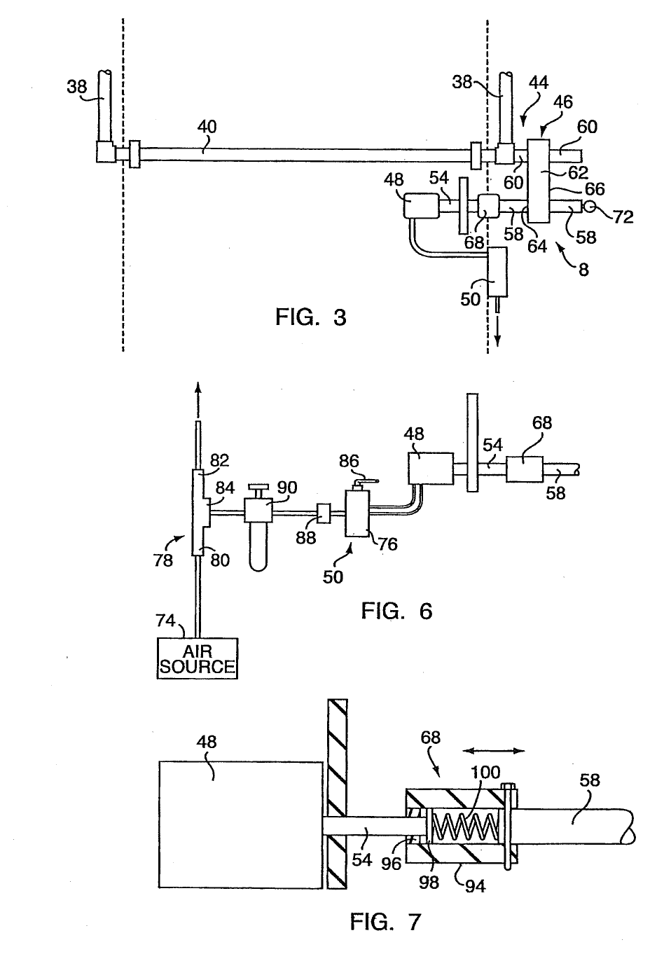

The present invention roll-out cover system 8 includes a drive mechanism 44 (see FIGS. 3 and 5), a motor 48, a gearbox 46, and a controller 50, operatively connected to a roll-out cover assembly 23. The roll-out cover assembly 23 includes a cover 26, a pair of pivot arms 38, a cover take-up roller 28, and in some embodiments a crossbar 34. The cover 26 has a trailing end 25 and a leading end 27 (see FIG. 2). The cover 26 may be made of a canvas material, a polymeric material or any other flexible material easily rollable around the take-up roller 28. Each of the pivot arms 38 has a pivot end 39 and a free end 41. One of the pivot arms 38 is mounted adjacent one of the container sidewalls 16, and the other pivot aim 38 is mounted adjacent the other container side wall 16. In those embodiments that include a crossbar 34, the crossbar 34 is disposed between and attached to the free end 41 of each pivot arm 38.

In some embodiments, the take-up roller 28 is attached to the front end of the container 14, or attached to the truck 10 adjacent the front of the container 14. In these embodiments, the trailing edge 25 of the cover 26 is attached to the take-up roller 28 and the leading end 27 of the cover 26 is attached to the crossbar 34. In other embodiments, the take-up roller 28 is either attached to the crossbar 34 or is disposed between the pivot arms 38 in place of the crossbar 34. In these embodiments, the trailing edge 25 of the cover 26 is attached to container 14 or the truck 10 adjacent the front of the container 14. The take-up roller 28 and the crossbar 34 (in certain embodiments) extend transversely across the width of the container 14. The cover 26 has a width and length sufficient to cover at least the open top of the container 14.

When the cover 26 is in the “uncovered” position (or “retracted” position), the pivoting arms 38 are pivoted towards the front end 30 of the container 14, and substantially all of the cover 26 is rolled around the take-up roller 28. When the cover 26 is in the “covered” position (or “substantially extended” position), the pivoting arms 38 are pivoted towards the rear end 36 of the container 14 and substantially all of the cover 26 is rolled out from the take-up roller 28. The take-up roller 28 includes, or operates in combination with, a mechanism operable to cause the cover 26 to roll onto the take-up roller 28; e.g., a biasing mechanism. Roll-out cover assemblies the same as, or similar to, that described above are known in the art and will not, therefore, be further described herein.

In the embodiment shown in FIG. 3, the pivoting arms 38 are joined together by a pivot shaft 40 transversely extending beneath the container 14. The movement of the pivoting arms 38, and thus the unrolling and rolling of the cover 26, is accomplished by driving the pivot shaft 40 with the present invention roll-out cover system 8.

The drive mechanism 44 of the present roll-out cover system 8 includes a drive shaft, which may be the pivot shaft 40 or otherwise operably connected to the pivot shaft 40. As shown in FIG. 3, the drive shaft acts as the pivot shaft 40. Thus, rotation of the pivot shaft 40 effects pivoting of the pivoting arms 38. The drive mechanism 44 is connected directly or indirectly to the gearbox 46 as described below.

Referring to FIGS. 3 and 5, the motor 48 of the present invention roll-out cover system 8 is mounted proximate to the gearbox 46, on one of the container 14 or the truck 10. The motor 48 includes an output motor shaft 54 operatively coupled to the gearbox 46. The motor 48 is preferably a commercially available pneumatic gear motor that is powered by an external air source as will be described below. A vane-type rotary driven motor having a gear reduction assembly with an 80-100 to 1 gear reduction ratio is favored. An example of an acceptable pneumatic gear motor is a WADCO pneumatic gear motor Model No. 33MA-220S1 produced by WADCO, a division of Ingersoll-Rand.

The gearbox 46 includes an input shaft 58 and an output shaft 60, connected to a plurality of gears (not shown). The gears are disposed within a housing 62 having a first side 64 and a second side 66 opposite one another. The input shaft 58 and the output shaft 60 extend outwardly from both the first side 64 and the second side 66. The gears are arranged to create mechanical advantage for the input shaft 58 relative to the output shaft 60; i.e., force transmitted to the input shaft 58 is multiplied through the gears to create a greater force available at the output shaft 60. The amount of mechanical advantage created by the gears can be varied to suit the application at hand. The input shaft 58 is adapted to receive a selectively removable hand crank (not shown) for manual rotation of the input shaft 58. When the hand crank is not attached, a knob 72 may be attached to the input shaft 58. In some embodiments, the gearbox 46 can be changed from a high gear to a low gear, or vice versa, by axially moving the knob 72 and input shaft 58 inward or outward, depending on the initial position of the input shaft 58 and the desired gear. Moving the input shaft 58 axially to change the gear causes the input shaft 58 extending out from both sides of the gearbox housing 62 to move axially.

A coupling 68 is used to connect the input shaft 58 of the gearbox 46 to the motor shaft 54 of the motor 48. In those embodiments where the gearbox 46 can be shifted between gears by axial movement of the input shaft 58, the coupling 68 accommodates the axial movement of the input shaft 58. An example of such a coupling 68 is diagrammatically shown in FIG. 7. In that embodiment, the coupling 68 includes a coupling housing 94, a motor shaft flange 96, a plate 98, and a spring 100. The coupling housing 94 has a gearbox end and a motor end for receiving and accommodating the input shaft 58 and the motor shaft 54 respectively. The motor shaft flange 96 is disposed adjacent the motor end of the coupling housing 94 and includes an aperture for slidably receiving the motor shaft 54. The input shaft 58 is received within and fixed to the gearbox end of the coupling housing 94. The spring 100 and the plate 98 are disposed within the coupling housing 94 with the spring 100 disposed adjacent the input shaft 58 and the plate 98 disposed adjacent the motor shaft 54. The plate 98 is retained by the motor shaft flange 96. Referring to FIGS. 3 and 5, the drive mechanism 44 is connected directly or indirectly to the output shaft 60 of the gearbox 46. A coupling, for example, can be used to directly connect the drive mechanism 44 to the output shaft 60. A chain drive, for example, can be used to indirectly connect the drive mechanism 44 to the output shaft. The specific means for mechanically connecting the output shaft 60 of the gearbox to the drive mechanism 44 can be varied to suit the application.

Referring to FIG. 6, the air source 74 for the preferred embodiment pneumatic motor is a portable source provided with the truck 10. Although an independent compressor (not shown) driven by a power source attached to the truck is acceptable, it is preferred to use an existing air supply from the brake system of the dump truck 10. The air supply for the emergency brake system is an example of an acceptable air source 74 in most cases. Alternatively, the air source 74 could be a cylinder attached to the container 14.

The controller 50 is provided to control the flow of compressed air to the motor 48. In a preferred embodiment, the controller 50 includes a valve 76 operatively coupled to the truck's emergency brake air supply to drive the motor 48, which in turn drives the gearbox shafts 58 and 60. In the preferred embodiment, a tee connector 78 is provided within the emergency brake line to tap airflow from the brake system. The tee connector 78 shown in FIG. 6, for example, has an input port 80 connected to receive airflow from the air source 74, a first output port 82 connected to the emergency brake system of the truck 10, and a second output port 84 connected to the motor 48. The controller mechanism 50 is provided between the tee connector 78 and the motor 48. In the preferred embodiment, the controller 50 includes a valve 76.

The valve 76 controls the direction and the amount of air received by the motor 48. In some embodiments, the valve 76 is a biased valve that provides air passage to the motor 48 only when the valve 76 is manually held in an open position (e.g., by manually holding the lever 86 in an “open” position). Once the lever 86 is released, the lever automatically returns to the “off” position, and the air supply to the motor 48 is terminated. This prevents the valve 76 from being left in a position where the air supply is only connected to the motor 48.

The preferred valve 76 is a three-position valve that includes an “off” position, a first supply position (“cover”), and a second supply position (“uncover”). As noted above, the valve 76 is biased to the “off” position. The lever 86 enables the operator to move the valve 76 between the “off” position and either of the first or second supply positions. The valve 76 is connected to the motor 48 in such a manner that air passing through the valve 76 when the valve is in the first supply position causes the motor 48 to rotate in a first direction (e.g., clockwise). Air passing through the valve 76 when the valve is in the second supply position causes the motor 48 to rotate in a second direction (e.g., counterclockwise). The valve 76 employs one or more air escape ports that utilize mufflers 88 to allow unneeded or excess air to escape. Pneumatic control valves are known in the art and the operation thereof need not be discussed further herein. The valves used in the operation described above are commercially available valves.

In alternative embodiments, the valve 76 can be a power-assisted type control valve that utilizes one or more solenoids, for example, to actuate the valve 76 to the first and/or second positions. Such a power-assisted valve may be configured so that the user operates the valve in proximity of the valve, or at a position remote from the valve, such as from the cab 12 of the truck 10. Even with such alternative valve designs, however, the valve 76 is preferably biased towards the “off” position.

In some embodiments, an automatic lubrication unit 90 (e.g., an oil mist lubricator) is provided upstream of the motor 48, and more preferably upstream of the motor 48 and the valve 76. The lubrication unit 90 treats the air with a fine oil mist so that the valve 76 and the motor 48 are lubricated so that they can operate efficiently. Automatic lubrication units are known in the art and will not, therefore, be further described herein.

In the operation of the present invention, the control valve 76 is moved into the first (or “cover”) valve position to extend the cover 26 over the open top of the container 14. In the “cover” position, the air source powers the motor 48, which in turn drives the gearbox 46 and attached drive mechanism 44. As a result, the pivot aims 38 are pivoted towards the rear end 36 of the container 14. The take-up roller 28 permits the cover 26 to roll out, but maintains a tension on the cover 26. Once the leading end of the cover 26 is disposed adjacent the rear end 36 of the container 14, the valve lever 86 is released and the valve 76 automatically returns to the “off” position. To uncover the container 14, the valve 76 is moved to the “uncover” position. In the “uncover” position, the air source powers the motor 48, and therefore the attached gearbox 46 and drive mechanism 44, in a rotational direction opposite that taken in the “cover” operation. As a result, the pivoting arms 38 are pivoted towards the front end 30 of the container 14, to roll-up the cover 26. The take-up roller 28 cooperates with the reverse pivoting of the aims 38 to roll the cover 26 around the take-up roller 28. The tension effected on the cover 26 by the take-up roller 28 facilitates the roll-up process. The tension also helps to maintain the pivot aims 38 in the “uncovered” position after the cover 26 has been rolled up onto the take-up roller 28. Once the cover 26 is rolled up, the valve lever 86 is released and the valve 76 automatically returns to its “off” position.

If an air source is not available to power the motor 48, the present invention system 8 can be manually operated with a hand crank. The hand crank is attached to the section of input shaft 58 extending out from the second side 66 of the gearbox housing 62 and cranked to rotate the pivot arms 38 and attached cover 26. The ability of the present system 8 to be manually operated provides significant advantage in situations where no air supply is available, and consequently more utility overall.

In the embodiment wherein the gearbox 46 can be shifted into a high gear or a low gear, the operation of the present system 8 is the same as that described above with the addition that the gear selection may be changed to suit the situation at hand. Specifically, the gearbox 46 can be shifted from one of the high gear or low gear to the other of the high gear or low gear by axially moving the input shaft 58. If, for example, the knob 72 and attached input shaft 58 are pushed inward to change gears, the input shaft 58 moves axially against the pressure of the spring 100 within the coupling 68. The coupling housing 94 moves axially along the motor shaft 54, compressing the spring 100. When the operator moves the knob 72 and input shaft 58 back into the original gear, the spring 100 acts against the input shaft 58 and returns the input shaft 58 to the first axial position associated with the original gear.

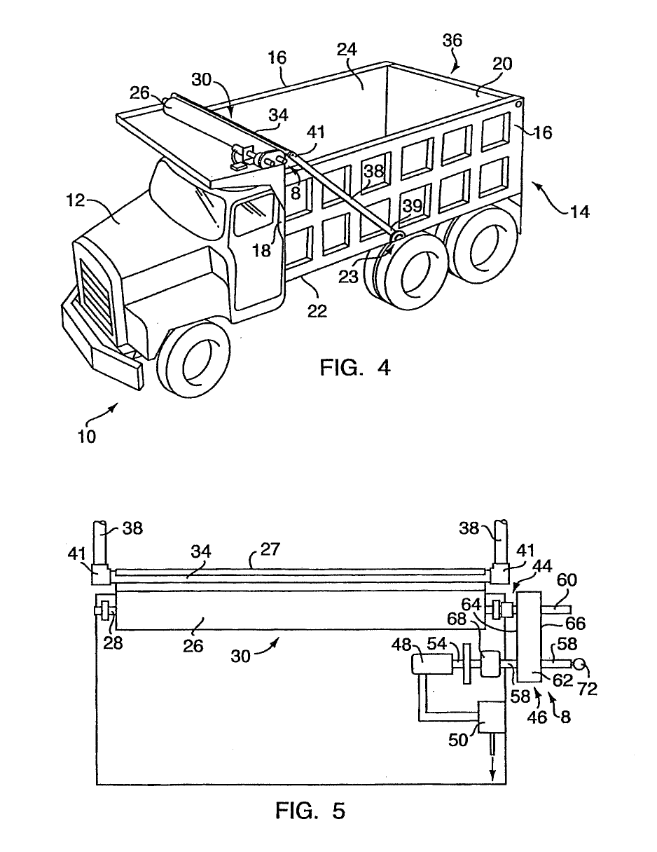

Now referring to FIGS. 4 and 5, in an alternative embodiment of the present invention, the present system 8 is operably connected to the take-up roller 28. The output shaft 60 of the gearbox 46 is connected to the take-up roller 28. The motor 48 is connected to the input shaft 58 in a manner the same as, or similar to, that described above. Rotation of the take-up roller 28 causes the cover 26 to be rolled in or out.

In this embodiment, the rolling-out or in of the cover 26 is conducted with the assistance of the pivoting arms 38. The pivoting arms 38 are biased towards the rear end 36 of the container 14. When the take-up roller 28 is rotated to roll out the cover 26, spring means (not shown) connected to the pivoting aims 38 help pivot the arms 38 towards the rear end 36 of the container 14 and maintain the cover 26 substantially taut. When the take-up roller 28 is rotated to roll in the cover 26, the power of the take-up roller 28 counteracts the spring means. The pivoting arms 38 are pivoted towards the front end 30 of the container 14 and held under tension when the cover 26 is completely rolled around the take-up roller 28. Various means for biasing the pivoting arms 38 are known, and are not discussed further herein. The gearbox 46, motor 48 and controller mechanism 50 of FIGS. 4-5 operate in the same manner as discussed above with respect to FIGS. 1-3.

An embodiment of the present invention roll-out cover system 8 is a retrofit kit for use with certain manual cover operating mechanisms to enable them to be operated in a power-assist mode. The retrofit kit includes a motor 48, a controller 50, and in some instances a gearbox 46. When the retrofit kit is combined with an existing manual cover operating mechanism that includes a gearbox, the motor 48 is coupled with the existing gearbox. The motor 48 and controller 50 are connected to an air source 74 as described above. When the retrofit kit is combined with an existing manual cover operating mechanism that does not include a gearbox, the gearbox 46 is coupled with the drive mechanism for the pivot arms 38 (or the take-up roller 28), and the motor 48 is coupled with the gearbox 46. The motor 48 and controller 50 are connected to an air source 74 as described above. In both instances, the operation of the retrofitted system is the same as or similar to that described above.

Although this invention has been shown and described with respect to the detailed embodiments thereof, it will be understood by those skilled in the art that various changes in form and detail thereof may be made without departing from the spirit and scope of the invention.

What is claimed is:

1. A roll-out cover system for a container mountable on a vehicle, which container has an open top, the system comprising:
a cover having a leading end and a trailing end, the trailing end being anchored adjacent a front end of the container;
a pair of pivot arms positioned on respective side walls of the container, each pivot arm having a free end connected to the leading end of the cover, and a pivot end, the pivot arms being pivotable between a first position wherein the cover is retracted from the open top, and a second position wherein the cover is extended substantially over the open top;
a gearbox having an input shaft and an output shaft;
a pneumatic motor coupled to the input shaft of the gearbox;
a drive mechanism coupled to the output shaft of the gearbox and connected to the pivot ends of the pivot arms;
a controller for selectively controlling a flow of air to the pneumatic motor, to enable operation of the drive mechanism and connected pivot arms between the first position wherein the cover is retracted, and the second position wherein the cover is extended substantially over the open top; and
a connector having an input port configured to receive compressed air from a source of compressed air, which source is integrated with the vehicle, a first output port configured to allow fluid communication with an emergency brake system of the vehicle, and a second output port configured to allow fluid communication with the controller, wherein the connector is configured so that air passing through the input port will access both the first and second output ports.

2. The roll-out cover system of claim 1, wherein the gearbox is adapted to receive a hand crank for manual rotation of the input shaft.

3. The roll-out cover system of claim 2, wherein the system may be operated in a power-assist mode or a manual mode.

4. The roll-out cover system of claim 1, wherein the gearbox comprises a plurality of gears shiftable between gear speeds of varying speeds.

5. The roll-out cover system of claim 4, further comprising a coupling that accommodates axial movement of the input shaft of the gearbox sufficient to effect shifting of the gears in the gearbox.

6. The roll-out cover system of claim 1, wherein the controller includes an airflow valve that is selectively positionable in a one or more supply positions and an off position, wherein the valve is normally biased in the off position, in which position the valve is operable to prevent air from the air source passing through to the pneumatic motor.
